(19) United States
(12) Patent Application Publication
(10) Pub. No.: US 2014/0074329 A1
(43) Pub. Date: Mar. 13, 2014

(54) VEHICLE ELECTRIC RANGE ESTIMATION

(71) Applicants: Hong Yang, Rochester Hills, MI (US); Steven L. Clark, Birmingham, MI (US); Feisel Weslati, Troy, MI (US); Carrie Okma, Birmingham, MI (US)

(72) Inventors: Hong Yang, Rochester Hills, MI (US); Steven L. Clark, Birmingham, MI (US); Feisel Weslati, Troy, MI (US); Carrie Okma, Birmingham, MI (US)

(73) Assignee: CHRYSLER GROUP LLC, Auburn Hills, MI (US)

(21) Appl. No.: 13/606,156

(22) Filed: Sep. 7, 2012

(51) Int. Cl. B60L 15/20

(52) U.S. Cl. 701/22; 180/65.285; 903/930

(57) ABSTRACT

A method and system of dynamically displaying a plurality of electric drive range estimations for a vehicle having an electric motor and an energy storage system configured to provide electric power to the electric motor. The display providing information to a driver such that an electric drive range of the vehicle can be optimized.

### FIELD

The present disclosure relates to a vehicle electric drive range display and, more specifically, to an electric drive range display of a battery electric vehicle (BEV), range extended electric vehicle (EREV), hybrid electric vehicle (HEV), or plug-in hybrid electric vehicle (PHEV).

### BACKGROUND

Motorized vehicles include a powertrain operable to propel the vehicle and power the onboard vehicle electronics. The powertrain typically includes an engine that powers the final drive system through a multi-speed transmission. Many of today's conventional, gas-powered vehicles are powered by an internal combustion (IC) engine.

A battery electric vehicle (BEV) is a type of electric vehicle (EV) that uses electric motors and motor controllers instead of IC engines for propulsion. BEVs use chemical energy stored in rechargeable batteries. A battery-only electric vehicle or all-electric vehicle derives all of its power from its batteries or battery packs and thus has no IC engine, fuel cell, or fuel tank. BEVs are also commonly referred to as all-electric vehicles.

Hybrid vehicles have been developed and continue to be developed. Conventional hybrid electric vehicles (HEVs) combine internal combustion engines with electric propulsion systems to achieve better fuel economy than non-hybrid vehicles. Plug-in hybrid electric vehicles (PHEVs) share the characteristics of both conventional hybrid electric vehicles and all-electric vehicles by using rechargeable batteries that can be restored to full charge by connecting, for example via a plug, to an external electric power source.

A range extended electric vehicle (EREV) shares similar powertrain architecture with an EV, with the exception of a downsized IC engine and electrical generator pair to charge the high voltage battery from on-board stored petroleum energy. EVs, PHEVs and EREVs share one common characteristic: all electric driving capability. The all electric drive capability and electric drive range depends largely on the size of the battery and electric propulsion system.

With some types of vehicles with pure electric drive capability a drawback is that the vehicle could run out of electric energy during an excursion. For PHEVs and EREVs, that means the IC engine has to turn on, which limits the zero emission driving capability. With an EV, that means the vehicle will run out of electric energy before reaching destination or charging station. Current electric drive range estimation capabilities are often inaccurate and may cause the vehicle to run out of electrical energy during an electric drive. Accordingly, there is a need for improvement in the art.

### SUMMARY

In one form, the present disclosure provides a method of dynamically displaying a plurality of electric drive range estimations for a vehicle having an electric motor, and an energy storage system configured to provide electric power to the electric motor, said method comprising the steps of estimating and displaying an instantaneous drivable electric drive range of the vehicle based on driving behavior; estimating and displaying a maximum drivable electric drive range of the vehicle; and estimating and displaying a minimum drivable electric drive range of the vehicle.

In another embodiment, the driving behavior is obtained from a current use of the vehicle. In yet another embodiment, the driving behavior is obtained from a previous use of the vehicle.

In some embodiments, at least one of the maximum drivable electric drive range, the minimum drivable electric drive range, or the instantaneous drivable electric drive range is determined in part from a standard driving schedule. In another embodiment, the standard driving schedule is an Urban Dynamometer Driving Schedule (UDDS). In another embodiment, at least one of the maximum drivable electric drive range, the minimum drivable electric drive range, or the instantaneous drivable electric drive range is determined in part from accessory energy consumption. In yet another embodiment, at least one of the maximum drivable electric drive range, the minimum drivable electric drive range, or the instantaneous drivable electric drive range is determined in part from driving behavior at least over a previous driving trip. In another embodiment, at least one of the maximum drivable electric drive range, the minimum drivable electric drive range, or the instantaneous drivable electric drive range is updated during a current trip based on available electric energy.

In some embodiments, the estimated instance drivable electric drive range, maximum drivable electric drive range and minimum drivable electric drive range are displayed in an image, wherein the image is selected from the group consisting of a bar graph, a pie chart, or a line graph.

In another embodiment, the method further comprises the step of displaying at least one electric drive range impact factor corresponding to a vehicle operating parameter controllable by a vehicle operator. In yet another embodiment, the at least one range impact factor comprises one of air conditioning, driving style, route selection, heating, vehicle weight, and ecological mode.

In another embodiment, at least one of the maximum drivable electric drive range, the minimum drivable electric drive range, or the instantaneous drivable electric drive range is estimated by dividing an energy storage system remaining capacity by an average energy consumption over a distance traveled by the vehicle. In some embodiments, an energy storage system remaining capacity estimation is determined based on a moving averaged energy storage system current usage and an energy storage system state of charge estimation and a total energy storage system capacity. In another embodiment, the energy storage system remaining capacity estimation is determined based on an energy storage system temperature, a state of health estimation, and a state of charge estimation.

In some embodiments, the instantaneous drivable electric drive range is further based on an average energy consumption calculated from a portion of a current trip and a remaining energy storage system capacity. In yet another embodiment, the minimum drivable electric drive range is based on a record of the most aggressive driving behavior and a remaining energy storage system capacity. In another embodiment, the at least one electric drive range impact factor affects at least one of the maximum drivable electric drive range, the minimum drivable electric drive range, or the instantaneous drivable electric drive range. In another embodiment, the maximum drivable electric drive range is based on a record of the most energy-conservative driving behavior and a remaining energy storage system capacity. In yet another embodiment, when a predetermined electric drive range impact factor threshold is displayed, a notification is provided to the vehicle operator. In another embodiment, the notification is selected from the group consisting of an audible sound, a different color electric drive range impact factor, a bold color electric drive range impact factor, or a blinking electric drive range impact factor.

In one form, the present disclosure provides a system for dynamically displaying a plurality of electric drive range estimations for a vehicle including an electric motor and an energy storage system configured to provide electric power to the electric motor, the system comprising an information display, for displaying a user interface, wherein the said interface comprises an instantaneous drivable electric drive range of the vehicle based on driving behavior; a maximum drivable electric drive range; a minimum drivable electric drive range; and at least one electric drive range impact factor corresponding to a vehicle operating parameter controllable by a vehicle operator.

In certain embodiments, the driving behavior is based on a current trip, the maximum drivable electric drive range is based on driving behavior at least from a previous trip, and the minimum drivable electric drive range is based on driving behavior at least from a previous trip.

Further areas of applicability of the present disclosure will become apparent from the detailed description, drawings and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 illustrates an example method of dynamically displaying a plurality of electric drive range estimations for a vehicle that includes an electric motor;

FIG. 2 illustrates a system of dynamically displaying a plurality of electric drive range estimations for a vehicle that includes an electric motor;

FIG. 3 illustrates an example display in accordance with an embodiment described herein;

FIG. 4 illustrates an example display in accordance with another embodiment described herein;

FIG. 5 illustrates an example display in accordance with another embodiment described herein; and

FIG. 6 illustrates a block diagram of a method of calculating a vehicle electric drive range estimation in accordance with disclosed principles.

### DETAILED DESCRIPTION

According to the principles disclosed herein, and as discussed below, the present disclosure provides a method and system of dynamically displaying a plurality of electric drive range estimations for a vehicle having an electric motor and an energy storage system configured to provide electric power to the electric motor. As disclosed herein, the information displayed will provide information to a driver such that a drivable electric drive range of the vehicle can be optimized. The information display may further include at least one electric drive range impact factor corresponding to a vehicle operating parameter controllable by the vehicle operator. The at least one electric drive range impact factor may affect at least one of the maximum drivable electric drive range, the minimum drivable electric drive range, or the instantaneous drivable electric drive range. Display of the impact factors provide the vehicle operator with real-time notice of predetermined vehicle operating parameters that affect vehicle range and with operator modification of certain vehicle parameters the operator can observe and better learn how to maximize vehicle operating range to vehicle operating conditions.

The present disclosure relates to an electric drive range display, particularly in vehicles such as PHEVs, BEVs, HEVs, and EREVs. A major component of PHEVs, BEVs, HEVs, and EREVs is an electric motor operable to provide torque to propel the vehicle, and an energy storage system, such as a battery or battery pack, configured to provide electric power to the electric motor.

In one embodiment, the present disclosure provides a method of dynamically displaying a plurality of electric drive range estimations for a vehicle having a pure electric drive capability, where the method comprises the steps of estimating and displaying an instantaneous drivable electric drive range (Range_Inst) of the vehicle based on driving behavior and remaining electrical energy in the energy storage system (Remaining Energy Storage System Capacity), estimating and displaying a maximum drivable electric drive range (Range_Hi) of the vehicle based on most energy-conservative driving behavior in the past and remaining energy storage system capacity; and estimating and displaying a minimum drivable electric drive range (Range_Lo) of the vehicle based on the most aggressive driving behavior in the past and remaining energy storage system capacity. In some embodiments, the electric drive range may be referred to as an electric vehicle range (EV Range).

The term “driving behavior” as used herein may include, but is not limited to, electric power consumption from the energy storage system for propelling the vehicle to meet the driver's demand as well as to power the vehicle electric accessory loads. The driving behavior may be taken from a current use of the vehicle, a past use of the vehicle, or both. In other embodiments, the driving behavior may be based on any data from a drive cycle. When the driving behavior is taken from a past use, or a combination of the current use and past uses, any number of past uses of the vehicle may be used. The term “state of charge” (“SOC”) as used herein may include, but is not limited to, the present energy storage system capacity as a percentage of maximum capacity. SOC may be typically calculated using current integration to determine the change in energy storage system capacity over time. The term “energy storage system” as used herein may include, but is not limited to, a battery, a battery pack, a battery cell, or a battery module. An energy storage system may also be any system for storing energy or electric power source. In a preferred embodiment, the energy storage system is a battery. The energy storage system may be rechargeable.

The present disclosure provides an electric drive range estimation with a confidence interval, for the purpose of providing a driver with intuitive, trustable, and predictable electric drive range information. electric drive range estimations may be dynamically displayed to provide the driver with trustable electric drive range information that may be calculated based on past or current driving trips. Data from any number of previous trips may be used. The range estimations also may be updated based on driving behavior during the current trip. Data from any duration of the current trip may be used. For example, in one embodiment, data over the past 5 minutes of driving time during the current trip may be used. In another example embodiment, data over the past 20 minutes of driving time during the current trip may be used. In one embodiment, an instantaneous drivable electric drive range is estimated and displayed. In another embodiment, any one of or any combination of three ranges may be dynamically displayed: a maximum drivable electric drive range, a minimum drivable electric drive range, and an instantaneous drivable electric drive range. The drivable electric drive range estimations may be based on any or all of a number of different factors, including, but not limited to a state of charge (SOC) of a rechargeable energy storage system or battery, total energy in the energy storage system, standard driving schedule such as an Urban Dynamometer Driving Schedule (UDDS), past or current driving behavior, past or current accessory energy consumption, weather, temperature, weight, or other factors.

In one example embodiment, one electric drive range estimation may be an optimistic electric drive range estimation based on a low-power drive cycle such as a UDDS cycle. Another electric drive range estimation for a low end conservative range estimation may be based on aggressive driving cycles from the past long-term drive history. Another electric drive range estimation may be based on short term average energy consumption of the current drive cycle. In certain embodiments, the driving behavior is based on a current trip, the maximum drivable electric drive range is based on long term driving behavior, and the minimum drivable electric drive range is based on long term driving behavior.

The present disclosure also relates to a method and system of educating a driver on the impact of his/her driving behaviors and other driving conditions on the electric drive range of the drive. This may be accomplished by an electric coaching capability. In some embodiments, the method may comprise the step of displaying at least one range impact factor indicating that a drivable electric drive range can be optimized. The driver may be shown a display where values are assigned to range impact factors showing either an increase or decrease in the drivable electric drive range with the use of a particular factor. Range impact factors may be e.g., air conditioning, heating, driving style, route selection, vehicle weight, ecological mode, or other factors.

As will be shown below, a drivable electric drive range is predicted and dynamically displayed. In a preferred embodiment, three numbers are predicted and dynamically displayed: a maximum drivable electric drive range, a minimum drivable electric drive range, and an instantaneous drivable electric drive range. The maximum drivable electric drive range may also be referred to as a high range or an optimistic range. The minimum drivable electric drive range may also be referred to as a low range, a worst case range, or a conservative range. In one embodiment, the minimum drivable electric drive range is a conservative electric drive range estimation based on worst case driving behavior and conditions estimated through long term learning, and having at least a 95% degree of certainty that the vehicle can achieve this range with the amount of electric energy left in the energy storage system, unless there is a drastic environmental change. In a preferred embodiment, the instantaneous drivable electric drive range is based on short-term learning of driver behavior. In some embodiments, the short-term learning may be moving-averaged energy consumption during the previous trip, past trips, or a combination of trips. In another embodiment, drivable electric drive range estimations may be updated during the current trip based on driving behavior during the trip. An electric drive range estimation may also be displayed with electric drive range impact factors, or electric drive range impact factors, that educate the driver on the impact and importance of different factors on total drivable electric drive range.

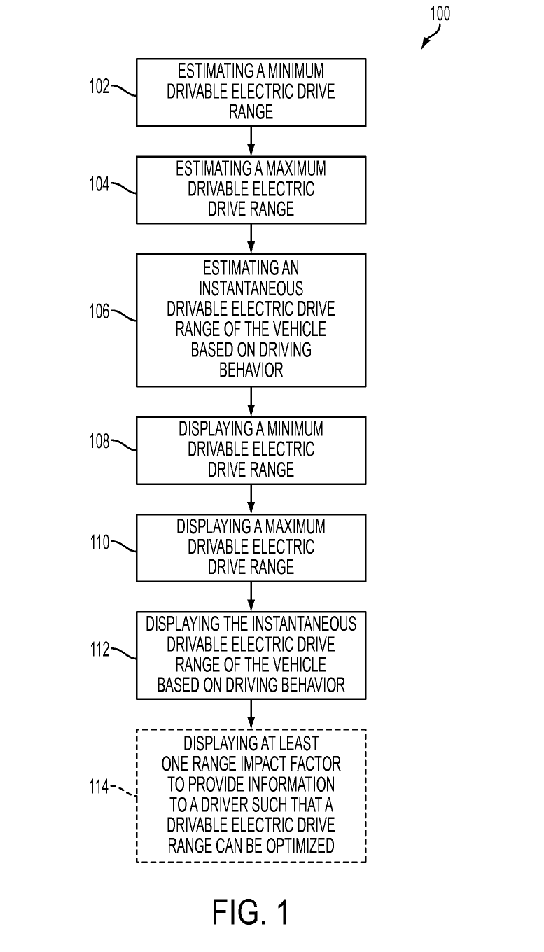

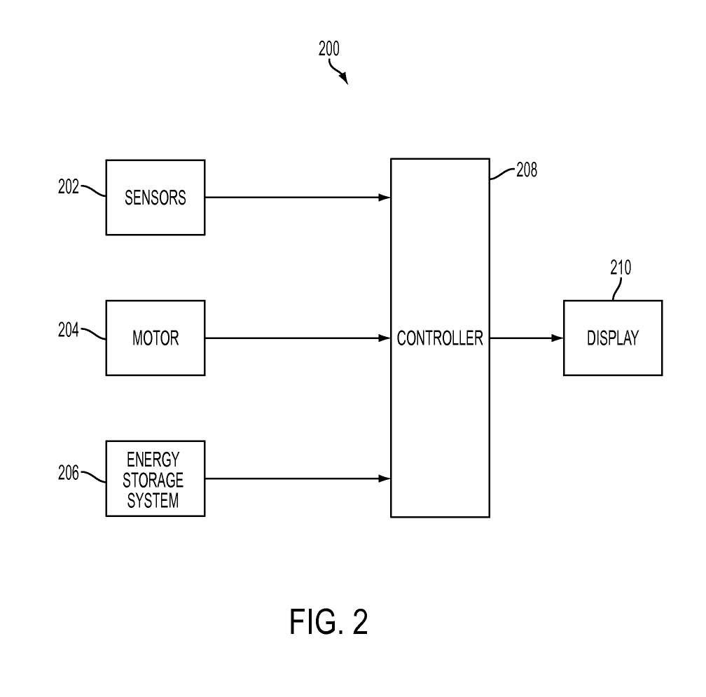

FIG. 1 illustrates a method 100 of dynamically displaying a plurality of electric drive range estimations for a vehicle having an electric motor 204 (FIG. 2). As is described below in more detail with reference to FIG. 2, the method 100 is performed on a controller 208 that is connected to a display 210 (FIG. 2). The method 100 may be implemented in software, in particular a sequence of controller execution instructions. The controller 208 may be a processor, a microprocessor, a microcontroller, or any device that incorporates the functions of a computer's central processing unit (CPU) onto a single or multiple integrated circuits. The controller 208 may be associated with a non-volatile memory (not shown), which may be part of the controller 208 or a separate component. It should be appreciated that any form of non-volatile memory may be used for memory.

In one embodiment, the method 100 first includes estimating a minimum drivable electric drive range in step 102. Then, step 104 estimates a maximum drivable electric drive range. Next, step 106 estimates an instantaneous drivable electric drive range of the vehicle based on driving behavior. In step 108, the minimum drivable electric drive range is displayed. In step 110, the maximum drivable electric drive range is displayed. In step 112, the instantaneous drivable electric drive range of the vehicle based on driving behavior is displayed. In other embodiments, after an estimation is performed it may then be displayed on the display 210. In another embodiment, the method 100 may include the step 114 of displaying at least one impact range factor to provide information to a driver how the drivable electric drive range can be optimized. In some embodiments, the estimating steps are all performed before the displaying steps. In other embodiments, a particular estimating step may be performed before a different estimating step that has already been performed is displayed. The estimating and displaying steps may take place in any order. The ranges are determined as discussed below (FIGS. 2-6).

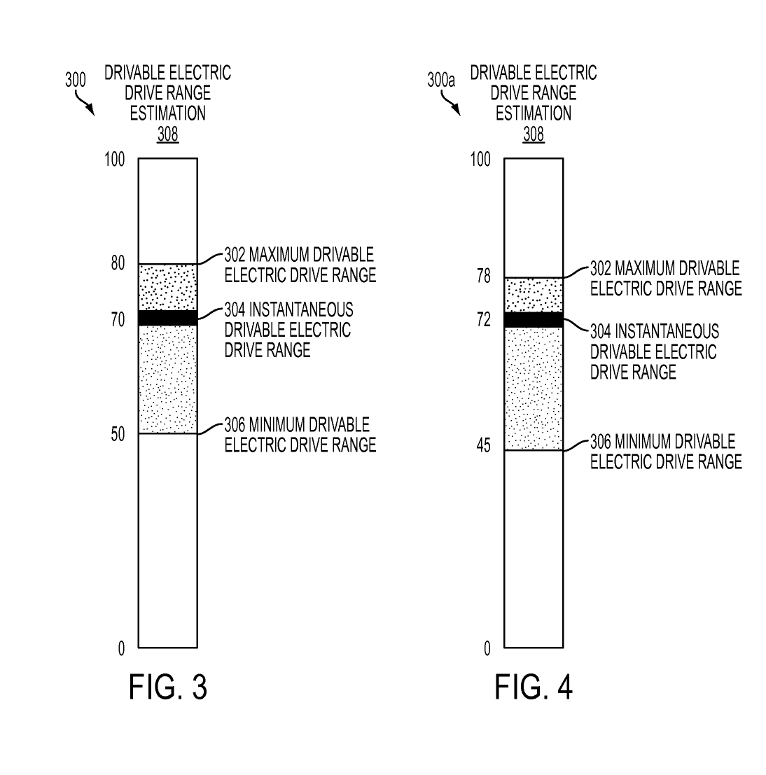

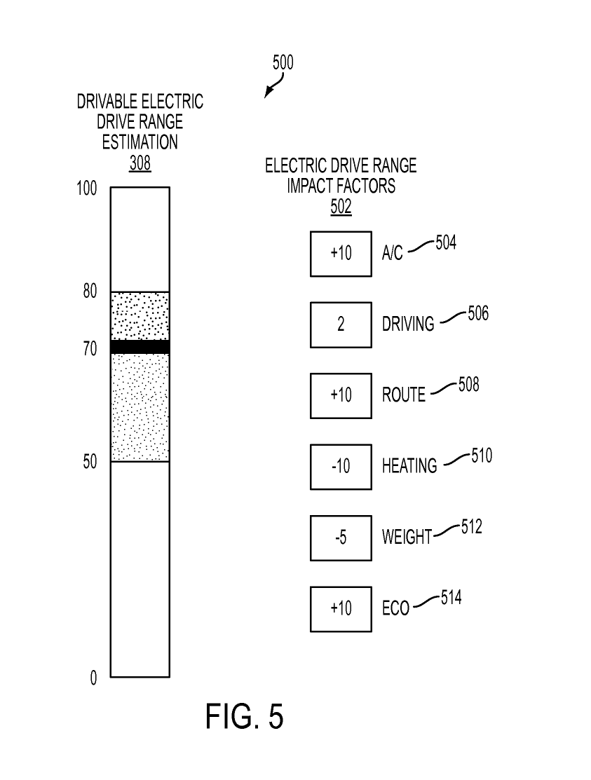

FIG. 2 illustrates one embodiment of a system 200 having a motor 204 and an energy storage system 206. In some embodiments, the energy storage system 206 may be an electric power source such as a battery, a battery pack, a battery cell, or battery module. The controller 208 receives input from the motor 204, energy storage system 206, and other system sensors 202. The sensors 202 may receive inputs for the estimation of electric drive range impact factors 502 (FIG. 5) which are sent to the controller 208 for processing. As discussed below in reference to FIGS. 3-5 the estimations from FIG. 1 are output to a display 210 within the vehicle. The motor 204 may be any type of electric propulsion system. The vehicle may have any number or different types of electric propulsion systems and a any number or different types of energy storage systems 206.

A UDDS drive cycle may be used in the drivable electric drive range estimations in the controller 208 and may be determined by the route selected or by past driving history. A highway drive cycle will typically give a lower drivable electric drive range estimation, and a city drive cycle such as UDDS will typically give a higher drivable electric drive range estimation.

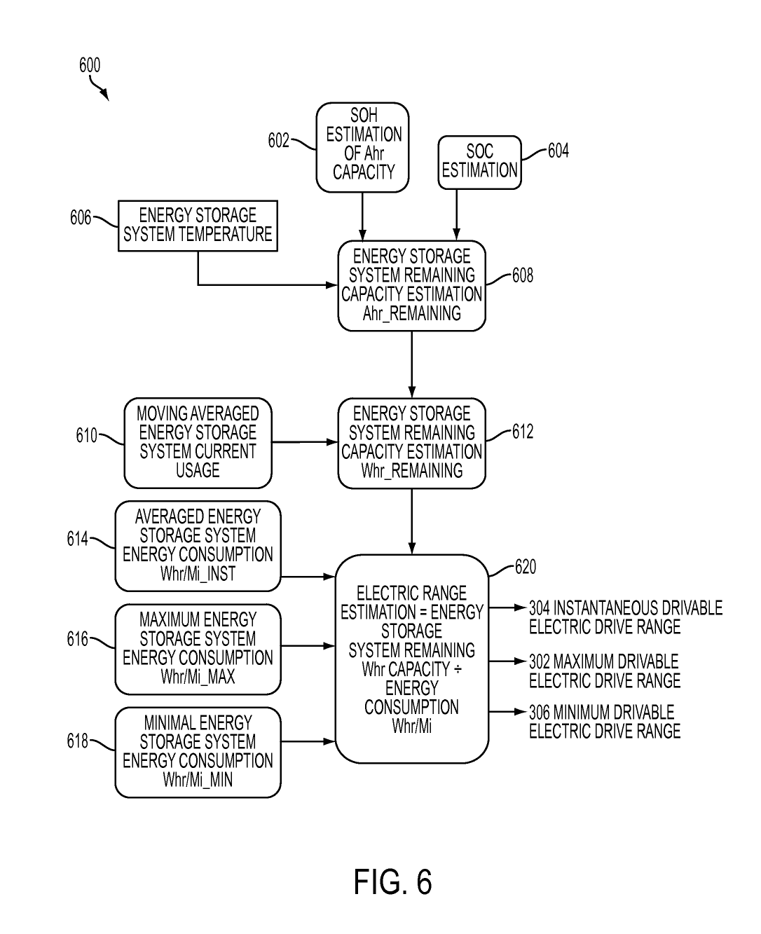

FIG. 3 illustrates a user interface 300 having a drivable electric drive range estimation 308 that is displayed on the display 210 (FIG. 2) as a graphical representation of a vehicle's electric drive range estimations with confidence interval. As described below (FIG. 6), the maximum drivable electric drive range 302, instantaneous drivable electric drive range 304, and minimum drivable electric drive range 306, are estimated by the controller 208 and then output to display 210. In one embodiment, the drivable electric drive range estimation 308 may be output on the display 210 at the start of the drive. The maximum drivable electric drive range 302, may also be referred to as a high range (Range_Hi). The instantaneous drivable electric drive range 304, may also be referred to as an instantaneous range (Range_Inst). The minimum drivable electric drive range 306 may also be referred to as a low range (Range_Lo). It should also be appreciated that the maximum drivable electric drive range 302, instantaneous drivable electric drive range 304, and minimum drivable electric drive range 306 may also be referred to by other names. The estimated instance drivable electric drive range, maximum drivable electric drive range and minimum drivable electric drive range may be displayed in an image such as a bar graph (FIG. 3), a pie chart, a line graph, or any other graph or graphical display.

FIG. 4 illustrates another user interface 300a having a electric drive range estimation 308a that has been updated during a drive based on current data from the drive. In the embodiment where electric drive range estimation 308 (FIG. 3) is shown to the driver at the start of the drive, range estimation 308a may then be displayed at a later point in time during the drive where the range estimations and confidence interval are updated based on current data from the drive. As shown in FIG. 4 as compared to FIG. 3, the maximum drivable electric drive range 302 has decreased from 80 to 78, the minimum drivable electric drive range 306 has decreased from 50 to 45, and the instantaneous drivable electric drive range 304 has increased from 70 to 72. In this embodiment, for example, the reasons the maximum drivable electric drive range 302 and minimum drivable electric drive range 306 have decreased may be due to environmental or system factors described above, as well as to a reduction of usable electric energy left in the energy storage system. As a result of a reduction of usable electric energy in the energy storage system while driving the vehicle electrically, the instantaneous drivable electric drive ranges estimation will decrease. In this embodiment, the instantaneous drivable electric drive range 304 may have increased for example due to the driver's driving behavior such as his/her driving style change that may result in low average electric energy consumption.

FIG. 5 illustrates another user interface 500 displayed on the display 210 in accordance with another embodiment described herein. The information display may further include at least one electric drive range impact factor corresponding to a vehicle operating parameter controllable by the vehicle operator. The at least one electric drive range impact factor may affect at least one of the maximum drivable electric drive range, the minimum drivable electric drive range, or the instantaneous drivable electric drive range. As shown in FIG. 5, the drivable electric drive range estimation 308 is shown with electric drive range impact factors 502. The electric drive range impact factors 502 may also be referred to as electric coaching factors. In FIG. 5, the interface 500 uses values assigned to the electric drive range impact factors 502 showing either an increase or decrease in the drivable electric drive range based on the impact of each particular factor to the electric drive range. For example, electric drive range impact factors 502 may include A/C 504, heating 510, driving 506, route 508, weight 512, ecological mode 514, or other factors. Any names describing these factors may be used in the user interface 500. For example, ecological mode 514 may also be called “Eco” or “Eco Mode.” The A/C factor 504 and heating factors 510 represent the air conditioning system and heating system of the vehicle, respectively, where a plus or minus range of the vehicle will be displayed based on how the electric drive range will be affected, decrease or increase, respectively when the air conditioning is on or off, or the heating system is on or off. The driving factor 506 represents how electric drive range is altered by the driving style or driving behavior of the driver of the vehicle and takes into account factors affecting level of propulsion power demands such as aggressiveness level of acceleration and deceleration of the vehicle and the average speed. Route factor 508 represents a route selection factor that may be used with a navigation system and/or a global positioning system (GPS), where the selected route's impact on vehicle electric drive range is displayed. Weight factor 512 represents the impact associated with the vehicle's weight, which may be measured by e.g., acceleration response and elevation information. Ecological factor 514 represents an ecological mode where the vehicle is placed into a more efficient energy conservation mode. The energy conservation mode may restrict the maximum allowable propulsion power and/or maximum electrical accessory loads, thus, to conserve electrical energy to extend the drivable electric drive range. For example, the ecological mode may set a limit for the propulsion power available for a maximum speed or for a rate of acceleration. As other examples, the ecological mode may limit the total available electrical power for the accessories, or limit the individual electrical power load for an accessory. The ecological mode may limit the individual electrical power available for an accessory, without necessarily simply turning off the individual accessory.

As shown in the FIG. 5 example, with the air conditioning off, a “+10” is displayed in the electric drive range impact factors 502 to show the driver that the drivable electric drive range is increased by 10 miles. In other embodiments, the drivable electric drive range numbers may represent a distance in miles, a distance in kilometers, a time, an energy storage system charge, or other units of measurement. It should be appreciated that the +/−range shown in the electric drive range impact factors 502 is not limited to +/−10, or +/−5.

In another embodiment, the numbers displayed for the electric drive range impact factors 502 may represent a scale, such as from 0 to 10. In a 0 to 10 scale of integer values (for example 0, 1, 2, 3, 4, 5, 6, 7, 8, 9, 10) where “10” may represent maximum energy savings, and “0” may represent minimum or no energy savings. For example, the air conditioning in an off position could be a “10” since there is no energy usage, whereas having the air conditioning on medium power could be a “5,” and having the air conditioning on full power could be a “0.” The range of the scale may be from negative to positive values, or span any number range. In other embodiments, other symbols may be used, such as letters of a grading scale from “A” to “F,” where “A” may represent maximum energy savings, and an “F” may represent minimum energy savings. In some embodiments, different scales or different units may be used for different electric drive range impact factors 502.

In some embodiments, where upon a predetermined electric drive range impact factors 502 minimum or maximum threshold is displayed, a notification is provided to the vehicle operator. For example, if the air conditioning is turned off, the corresponding electric drive range impact factor could display a bold green “10” or display a green scale box, and if the air conditioning is turned on to full power, the corresponding electric drive range impact factor could display a bold red “0” or display a red scale box. The notifications may be an audible notice (a chime), a different and/or bold color of the electric drive range impact factors 502, a blinking electric drive range impact factors 502 scale box, and combinations thereof.

When at least one electric range impact factor corresponding to a vehicle operating parameter controllable by the vehicle operator is displayed to the vehicle operator, the operator may then react to the displayed information of the electronic range impact factor 502 by adjusting their driving behavior to maximize their electric drive range. For example, upon the vehicle operator seeing an electronic range impact factor 502 display at a low value, such as below a 5 on a 0 to 10 scale, for example a 3 for A/C factor 504, the operator may take corrective action, such as reducing the A/C level or turning it off or to say plain vent outside air. The operator may also take corrective action upon seeing a drastic change in the values of an electric drive range impact factor, such as an 8 to a 3 on a 0 to 10 scale. This corrective action may result in an improvement to the corresponding electronic range impact factor 502, which the operator may notice and consequently learn from. The vehicle operator may then see a noticeable improvement in the corresponding electronic range impact factor 502 As another example, the operator upon seeing a non-optimal number for the selected routes, may instead select and drive according to a more optimized electric range route (shorter, less hills, etc.) resulting in a noticeable improvement in the corresponding electronic range impact factor 502.

FIG. 6 illustrates a block diagram of a method 600 of calculating the vehicle electric drive range estimation. In some embodiments, the blocks of method 600 may be calculated in the controller 208. In other embodiments, some or all of the information in or calculations from the blocks of method 600 may be sent to the controller 208 for display after being determined in other locations in the vehicle. In block 602, a state of health (SOH) estimation of amp-hours (Ahr) capacity is performed. The SOH may represent the total available capacity of the energy storage system. In a preferred embodiment, the energy storage system may be a battery. A state of charge (SOC) estimation is performed in block 604. The energy storage system temperature (block 606) may be input from a sensor and used with the SOH and SOC to determine the energy storage system remaining capacity estimation (Ahr_remaining) in block 608. In a preferred embodiment, the energy storage system temperature of block 606 may be a battery or battery pack temperature. Ahr_remaining estimation from block 608 is taken with the moving averaged current usage (block 610) of the energy storage system to calculate the energy storage system remaining capacity estimation in Watt hours (Whr) remaining (Whr_remaining in block 612). The block 610 may also take into account data from the drive cycle, such as driving behavior, as well. Energy storage system Energy Consumption is typically represented by Whr/Mi or Watt hours per mile, but may also be represented by other units. The moving averaged electric current usage of the energy storage system may be calculated based on the averaged electric current consumption during the past drive history. The averaged energy storage system energy consumption Whr/Mi_Inst (block 614) is the averaged energy consumption of the energy storage system. The maximum energy storage system energy consumption Whr/Mi_Max (block 616) is the maximum energy consumption of the energy storage system in Whr/Mi_Max. The minimal energy storage system energy consumption Whr/Mi_Min (block 618) is the minimum energy consumption of the energy storage system in Whr/Mi_Min. The averaged energy consumption Whr/Mi_Inst (block 614) of the energy storage system, the maximum energy consumption Whr/Mi_Max (block 616) of the energy storage system, and the minimum energy consumption of the energy storage system Whr/Mi_Min (block 618) are input into block 620 with the energy storage system remaining capacity estimation from block 612 to calculate each electric range estimation in block 620. In some embodiments, the minimal energy consumption Whr/Mi_Min of block 618 is calculated based on a standard driving cycle with low power demands such as a UDDS cycle. In some embodiments, in block 616, the maximum energy consumption of the energy storage system may be calculated over a long term. The energy consumption Whr/Mi_Min (block 618) of the energy storage system represents the minimum energy consumption. These electric range estimations are then output to the display 210 (FIG. 2) as Instantaneous Drivable Electric Drive Range 304, Maximum Drivable Electric Drive Range 302, and Minimum Drivable Electric Drive Range 306 respectively (FIGS. 3-5). Whr/Mi_Max may also be referred to herein as Whr/Mi_Hi, and Whr/Mi_Min may also be referred to herein as Whr/Mi_Lo. The Energy Consumption in Whr/Mi in blocks 614, 616, and 618 may be calculated in the controller 208. In other embodiments, the Energy Consumption in Whr/Mi in blocks 614, 616, and 618 may be determined at another location in the vehicle, and then sent to the controller 208.

What is claimed is:

1. A method of dynamically displaying a plurality of electric drive range estimations for a vehicle having an electric motor, and an energy storage system configured to provide electric power to the electric motor, said method comprising the steps of:
estimating and displaying an instantaneous drivable electric drive range of the vehicle based on driving behavior;
estimating and displaying a maximum drivable electric drive range of the vehicle; and
estimating and displaying a minimum drivable electric drive range of the vehicle.

2. The method of claim 1, wherein the driving behavior is obtained from a current use of the vehicle.

3. The method of claim 1, wherein the driving behavior is obtained from a previous use of the vehicle.

4. The method of claim 1, wherein at least one of the maximum drivable electric drive range, the minimum drivable electric drive range, or the instantaneous drivable electric drive range is determined in part from a standard driving schedule.

5. The method of claim 4, wherein the standard driving schedule is an Urban Dynamometer Driving Schedule.

6. The method of claim 1, wherein at least one of the maximum drivable electric drive range, the minimum drivable electric drive range, or the instantaneous drivable electric drive range is determined in part from accessory energy consumption.

7. The method of claim 1, wherein at least one of the maximum drivable electric drive range, the minimum drivable electric drive range, or the instantaneous drivable electric drive range is determined in part from driving behavior at least over a previous driving trip.

8. The method of claim 1, wherein at least one of the maximum drivable electric drive range, the minimum drivable electric drive range, or the instantaneous drivable electric drive range is updated during a current trip based on available electric energy.

9. The method of claim 1, wherein the estimated instance drivable electric drive range, maximum drivable electric drive range and minimum drivable electric drive range are displayed in an image, wherein the image is selected from the group consisting of a bar graph, a pie chart, or a line graph.

10. The method of claim 1, further comprising the step of:
displaying at least one electric drive range impact factor corresponding to a vehicle operating parameter controllable by a vehicle operator.

11. The method of claim 10, wherein the at least one range impact factor comprises one of air conditioning, driving style, route selection, heating, vehicle weight, and ecological mode.

12. The method of claim 1, wherein at least one of the maximum drivable electric drive range, the minimum drivable electric drive range, or the instantaneous drivable electric drive range is estimated by dividing an energy storage system remaining capacity by an average energy consumption over a distance traveled by the vehicle.

13. The method of claim 12, wherein an energy storage system remaining capacity estimation is determined based on a moving averaged current usage of the energy storage system and a state of charge estimation of the energy storage system and a total capacity of the energy storage system.

14. The method of claim 13, wherein the energy storage system remaining capacity estimation is determined based on an energy storage system temperature, a state of health estimation, and a state of charge estimation.

15. The method of claim 10, wherein when a predetermined electric drive range impact factor threshold is displayed, a notification is provided to the vehicle operator.

16. The method of claim 15, wherein the notification is selected from the group consisting of an audible sound, a different color electric drive range impact factor, a bold color electric drive range impact factor, or a blinking electric drive range impact factor.

17. The method of claim 10, wherein the at least one electric drive range impact factor affects at least one of the maximum drivable electric drive range, the minimum drivable electric drive range, or the instantaneous drivable electric drive range.

18. A system for dynamically displaying a plurality of electric drive range estimations for a vehicle including an electric motor and an energy storage system configured to provide electric power to the electric motor, the system comprising:
an information display, for displaying a user interface, wherein the said interface comprises:
an instantaneous drivable electric drive range of the vehicle based on driving behavior;
a maximum drivable electric drive range;
a minimum drivable electric drive range; and
at least one electric drive range impact factor corresponding to a vehicle operating parameter controllable by a vehicle operator.

19. The system of claim 18, further comprising a plurality of sensors adapted to measure driving behaviors and electric drive range impact factors.

20. The system of claim 18, wherein the driving behavior is based on a current trip;
the maximum drivable electric drive range is based on driving behavior at least from a previous trip; and
the minimum drivable electric drive range is based on driving behavior at least from a previous trip.
